(19) United States
(12) Patent Application Publication
(10) Pub. No.: US 2013/0168364 A1
(43) Pub. Date: Jul. 4, 2013

(54) GO/NO GO BALL FEELER GAUGE FOR PARTS CHECKING JIGS AND METHOD

(71) Applicants: Daniel J. Ketelaar, Sand Lake, MI (US); David L. Schuiling, Belmont, MI (US); Thomas K. Nagle, Grand Rapids, MI (US)

(72) Inventors: Daniel J. Ketelaar, Sand Lake, MI (US); David L. Schuiling, Belmont, MI (US); Thomas K. Nagle, Grand Rapids, MI (US)

(21) Appl. No.: 13/595,115

(22) Filed: Aug. 27, 2012

Related U.S. Application Data
(60) Provisional application No. 61/581,244, filed on Dec. 29, 2011.

(51) Int. Cl. B23K 26/32; B23H 1/00

(52) U.S. Cl. 219/69.17; 219/121.64

(57) ABSTRACT

A go/no go ball feeler gauge includes a ball that is laser-welded to a rod. The rod is preferably cut utilizing an EDM process to provide a flat end to which the metal ball is laser-welded. Also, the metal ball is selected to have an initial size that is about 2 microns less than a final required size, and the laser welding process causes the ball to expand to the required diameter.

### CROSS REFERENCE TO RELATED APPLICATION

This application claims the benefit of U.S. Provisional Patent Application No. 61/581,244 filed on Dec. 29, 2011, entitled “GO/NO GO BALL FEELER GAUGE FOR PARTS CHECKING JIGS AND METHOD,” the entire contents of which is incorporated by reference.

### BACKGROUND OF THE INVENTION

Various fixtures, jigs, and the like have been developed for checking the dimensions of parts to determine if the parts are within predefined tolerance limits. Known fixtures may include precise surfaces that contact a surface of a part when the part is placed in the fixture to thereby locate/position a part. The surfaces of the fixture are configured to provide a precise predefined gap between the fixture and the part surface. If the part surface is out of tolerance, the gap between the two surfaces will fall outside of a predefined acceptable range. To determine if a part is within tolerance, a part is placed in the fixture, and a “go/no go” gauge is positioned between the part and the fixture of the surface.

Known go/no go feeler gauges may include elongated rods (e.g. drill rods) that are connected to a center handle using collets. Circular balls are secured to the outer ends of the rods. Typically, a smaller spherical steel ball is placed at a “go” end of a first rod, and a slightly larger “no go” spherical steel ball is positioned at the end of the other rod.

In use, the spherical balls are moved between the surface of the part and the check fixture. If a part is within tolerance, the smaller spherical ball will fit into the gap, but the larger spherical ball will not fit through the gap.

Existing go/no go feeler gauges of this type are typically constructed by adhesively securing the spherical steel balls to the end of the steel rods. However, existing feeler gauges of this type may suffer from various drawbacks.

### SUMMARY OF THE INVENTION

One aspect of the present invention is a go/no go ball feeler gauge of the type utilized for parts checking jigs, and a method of fabricating a gauge. The method includes providing a metal rod comprising a first metal material and having first and second opposite ends. The method also includes determining a required diameter for a solid sphere whereby the solid sphere can be utilized as a go or no/go gauge. A metal ball is provided, wherein the metal ball has a spherical outer surface defining a diameter that is substantially the same as the required diameter. The metal ball is preferably made of the first metal material of the metal rod. The metal ball is positioned adjacent the first end of the rod, and the metal ball is welded to the first end of the rod utilizing a laser welding process. The diameter of the metal ball prior to welding is preferably about 2 microns less in diameter than the required diameter, such that expansion of the metal ball due to the welding process results in a metal ball having the previously determined required diameter.

### BRIEF DESCRIPTION OF THE DRAWINGS

FIG. 1 is an isometric view of a jig having a part to be checked positioned in the jig;

FIG. 2 is a fragmentary isometric view showing an enlarged portion of the part and jig of FIG. 1;

FIG. 3 is a fragmentary isometric view showing use of a “go” ball end of a go/no go gauge in conjunction with the part and fixture of FIGS. 1 and 2;

FIG. 4 is a fragmentary side elevational view of a handle of a go/no go feeler;

FIG. 5 is an isometric view of a “no go” spherical gauge in use;

FIG. 6 is a fragmentary side elevational view showing a “go” end of a spherical ball gauge; and

FIG. 7 is a fragmentary cross-sectional view of a spherical ball secured to an end of a rod to form a “go” or “no go” gauge.

### DETAILED DESCRIPTION

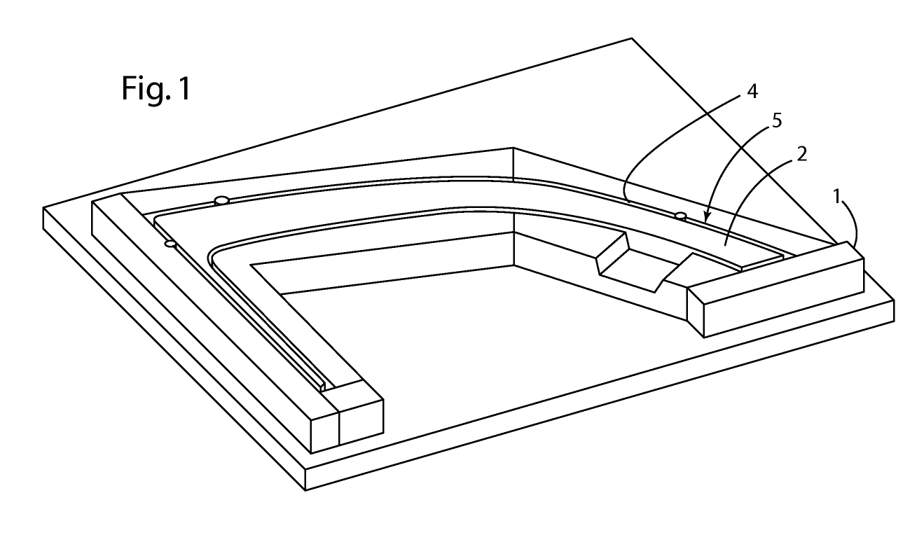

For purposes of description herein, the terms “upper,” “lower,” “right,” “left,” “rear,” “front,” “vertical,” “horizontal,” and derivatives thereof shall relate to the invention as oriented in FIG. 1. However, it is to be understood that the invention may assume various alternative orientations, except where expressly specified to the contrary. It is also to be understood that the specific devices and processes illustrated in the attached drawing, and described in the following specifications are simply exemplary embodiments of the inventive concepts defined in the appended claims. Hence, specific dimensions and other physical characteristics relating to the embodiments disclosed herein are not to be considered as limiting, unless the claims expressly state otherwise.

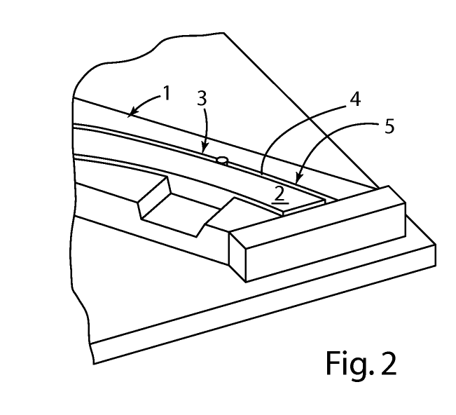

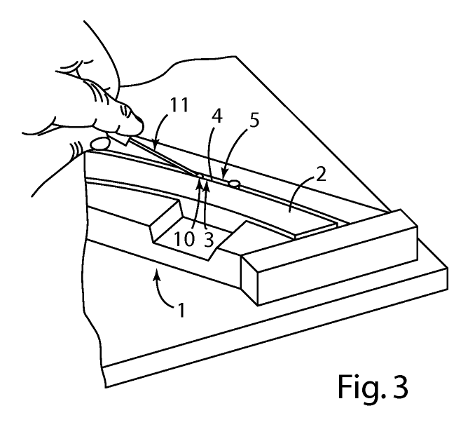

With reference to the photographs marked FIGS. 1 and 2, a jig 1 is configured to retain and position a part 2 that is to be checked to determine if the part 2 is within predefined tolerances. With further reference to FIG. 3, the jig 1 may include a plurality of surfaces 3 having a surface contour closely corresponding to a surface 4 of a part 2. The part 2 may comprise formed sheet metal or other component having a surface 4 that must be within a specified tolerance. The surface 3 of the jig is configured to provide a gap 5 between the jig surface 3 and part surface 4. The jig 1 and part 2 may comprise conventional components of a known type, and they will therefore not be described in detail.

In use, a spherical ball 10 of a go/no go gauge 11 is positioned in the gap 5. The go/no go gauge 11 includes a smaller spherical “go” ball, and a somewhat larger spherical “no go ball.” If the part 2 is within a predefined acceptable tolerance, the smaller “go” spherical ball will fit into the gap 5, whereas the larger “no go” spherical ball will not fit into the gap 5. Conversely, if the larger “no go” spherical ball does fit into the gap 5, the part 2 is not within the allowable tolerance. Similarly, if the smaller “go” spherical ball does not fit into the gap 5, this also means that the part 2 is not within the predefined allowable tolerance.

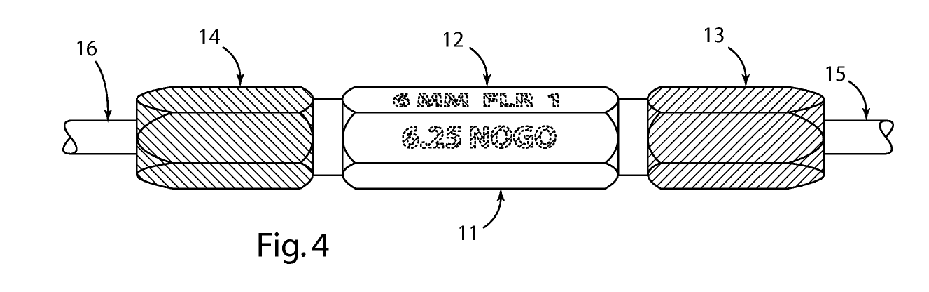

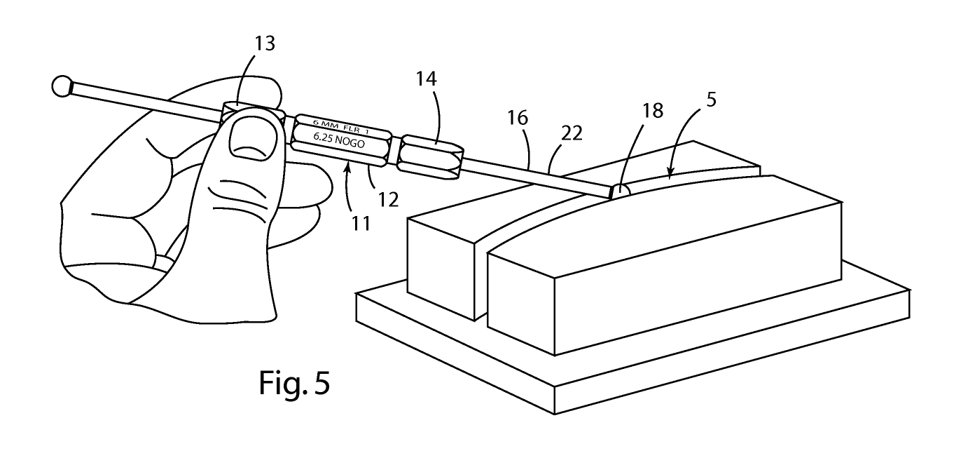

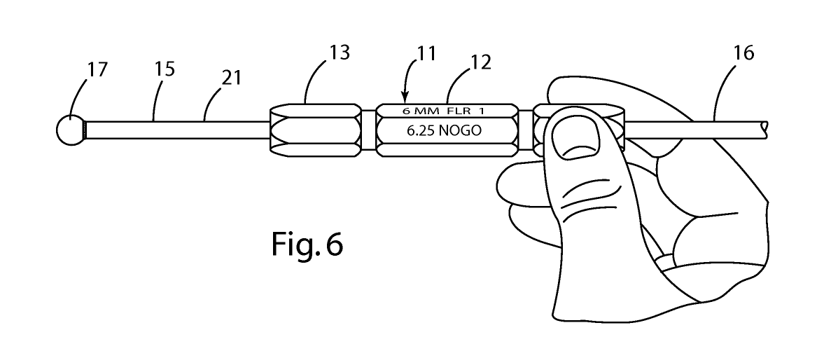

With further reference to FIG. 4, a go/no go gauge 11 according to one aspect of the present invention includes a center 12 having a hexagonal cross-sectional shape, and collets 13 and 14 that removably secure a go rod assembly 15 (FIG. 6), and a no go rod assembly 16 (FIG. 5). The go rod assembly 15 includes a spherical ball 17 at the end of a steel rod 21 (FIG. 6), and no go rod assembly 16 (FIG. 5) includes a spherical no go ball 18 that is secured to an end of a rod 22. The rods 21 and 22 may comprise a metal (e.g. steel) rod, and the go ball 17 and no go ball 18 may be spherical metal (e.g. steel) balls.

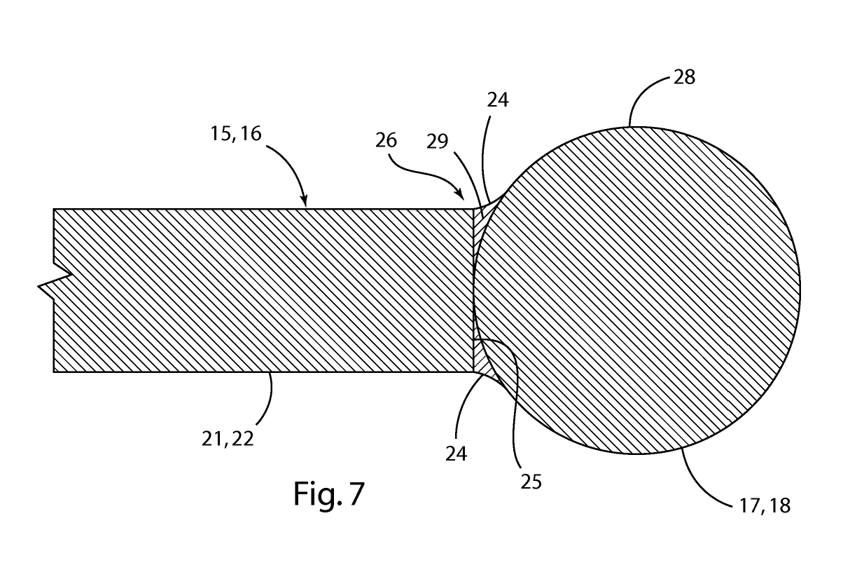

With further reference to FIG. 7, a gauge and rod assembly 15 or 16 according to the present invention may include a spherical steel ball 17 or 18 that is laser welded to form solidified weld material 24 to a steel rod 21 or 22. Although various laser welders could be utilized, a preferred laser welder comprises an ALPHA LASER unit that is available from ALPHA LASER GmbH, Zeppelinstr.1; 82178 Puchheim. The laser is typically set at between about 180-210 volts. A flat end surface 25 is formed at end 26 of a rod 21 or 22 prior to securing the spherical ball 17 or 18 to the rod 21 or 22 by laser welding. The flat end surface 25 may be formed by cutting the rod using a wire Electron Discharge Machine (“EDM”), or other suitable process. The length of the rod is generally in the range of about two to eight inches, and the rod is most preferably about five inches long. The rods preferably comprise 308 stainless steel. Flat end surface 25 defines an annular edge 27 around end 26 of rod 21 or 22. The edge 27 is spaced apart slightly from spherical outer surface 28 of a steel ball 17 or 18 to define a small gap 29 that is all or partially filled with solidified weld material 24. Filler material in the form of 410 stainless steel in the range of about 0.010-0.015 inches thick is used at the weld.

A fixture (not shown) may be utilized to position the ball 17, 18 on the end 26 of rod 15, 16 in contact with flat end surface 25 during the laser welding process. Alternately, the ball 17, 18 and/or rod 15, 16 may be held in place by hand during the laser welding process. Although the balls 17, 18 are preferably brought into contact with surface 25 immediately prior to the laser welding process, actual contact is not required and the balls 17, 18 may be positioned directly adjacent the surface 25.

The spherical ball 17 or 18, and the rod 21 or 22 may both comprise stainless steel or other suitable material. In general, the rod 21 or 22 has a diameter that is significantly less than a diameter of the steel ball 17 or 18. A rod 21 having a relatively small diameter is preferably utilized in connection with a smaller go ball 17, and a somewhat larger diameter rod 22 is utilized in connection with a somewhat larger no go ball 18. In particular, stainless steel rods having a diameter of 0.125 inch are used for test balls having a diameter of 6.00 mm or more, 0.062 inch diameter SAE type 308 stainless steel rods are utilized for test balls having a diameter of about 2.50 mm-5.90 mm, and 0.035 inch diameter 308 stainless steel rod material is used for test balls having a diameter in the range of about 2.00 mm-2.4 mm. A mild steel MIG (Metal Inert Gas) wire is used for test balls having a diameter below about 2.00 mm. The test balls are preferably chrome (chromium) steel grade 25.

Prior to laser welding the spherical ball 17 or 18 to the rod 21 or 22, the required final size for the test ball is determined. A test or gauge ball having a diameter of about 2 microns smaller than the final dimension is selected. The ball 17 or 18 is then clamped or otherwise retained in contact (e.g. by hand) with the flat end surface 25 of the rod, and a laser weld 24 is formed in a continuous ring at the intersection of edge 27 and the spherical ball 17 or 18. The diameter of the spherical ball 17, 18 increases by about 2 microns as a result of the laser welding process, such that the final diameter of the spherical ball 17 or 18 is precisely the required final size.

A go/no go feeler gauge according to the present invention may include, for example, a “go” spherical ball having a diameter of 5.65 millimeters, and a “no go” spherical ball of 6.35 millimeters. Another example is a feeler gauge having a 5.0 millimeter “go” spherical ball, and a 6.5 millimeter “no go” spherical ball. Typical test ball sizes are in the range of about 2.0 mm- about 12.0 mm. However, it will be understood that the spherical go and no go balls may have virtually any dimension as required for a particular application. In general, the steel rods have a diameter that is significantly less than that of the spherical balls. Although the precise diameter of the rod is not critical, the rod will typically have a diameter that is about ¼ to about ½ the diameter of the spherical test ball to provide clearance during use, while still providing a suitably strong construction.

Laser welding of the gauge balls onto the rods provides a durable gauge that is not prone to detachment of the test balls as may occur if the balls are adhesively bonded to the rods. Although the feeler gauge has been described in connection with a jig and a part to be checked in the jig, it will be understood that the feeler gauge of the present invention may be utilized in a wide range of applications.

It is to be understood that variations and modifications can be made on the aforementioned structure without departing from the concepts of the present invention, and further it is to be understood that such concepts are intended to be covered by the following claims unless these claims by their language expressly state otherwise.

The invention claimed is:

1. A method of fabricating a gauge for checking a dimension to determine if the dimension is within a predefined allowable range, the method comprising:
providing a metal rod comprising a first metal material and having first and second opposite ends;
determining a required diameter for a solid sphere whereby the solid sphere can be utilized as a go or no-go gauge;
providing a metal ball having a spherical outer surface defining a diameter that is substantially the same as the required diameter, wherein the metal ball is made of the first metal material;
positioning the metal ball adjacent the first end of the rod;
welding the metal ball to the first end of the rod utilizing a laser welding process.

2. The method of claim 1, wherein:
determining a required diameter for a solid sphere includes determining a final diameter, and determining an initial diameter that is about two microns less than the final diameter;
the metal ball increases about two microns in diameter after laser welding of the metal ball to the metal rod whereby a final diameter of the metal ball is about equal to the final diameter that was previously determined.

3. The method claim 1, wherein:
the first end of the metal rod is substantially flat prior to welding the metal ball to the first end of the metal rod utilizing the laser welding process.

4. The method of claim 1, wherein:
the metal rod has a diameter in the range of about 0.035 inches to about 0.125 inches, and the metal ball has a diameter in the range of about 2.00 mm to about 12.00 mm.

5. The method of claim 4, wherein:
the metal rod has a length in the range of about 2 inches to about 8 inches.

6. The method of claim 5, wherein:
welding the metal ball to the first end of the metal rod includes bringing the metal ball into contact with the end of the rod while it is being welded.

7. The method of claim 1, wherein:
providing a metal rod includes cutting an elongated piece of metal utilizing an EDM process to cut the rod to a predefined length;
the first end of the rod is formed by EDM cutting.

8. The method of claim 7, wherein:
the rod has a cylindrical outer surface defining an axis, and the first end has a flat surface that is perpendicular to the axis.

9. The method of claim 1, wherein:
the metal ball comprises a first ball having a first diameter; and includes;
providing a second metal ball having a second diameter that is larger than the first diameter whereby;
providing a second metal rod having first and second opposite ends;
positioning the second metal ball adjacent the first end of the second metal rod;
welding the second metal ball to the first end of the second rod utilizing a laser welding process.

10. The method of claim 9, includes:
providing a handle;
securing the second ends of the first and second rods to the handle.
